(19) United States
(12) Patent Application Publication
(10) Pub. No.: US 2001/0044378 A1
(43) Pub. Date: Nov. 22, 2001

(54) Absorbent material and method of production

(76) Inventors: Graham E. Steer, London (GB); Padraig G. Troy, W. Sussex (GB)

Correspondence Address: Stuart E. Krieger, c/o Bristol-Myers Squibb Company, 100 Headquarters Park Drive, Skiillman, NJ, 08558, US

(21) Appl. No.: 09/833,440

(22) Filed: Apr. 12, 2001

(30) Foreign Application Priority Data
Apr. 13, 2000 (EP) EP 00 303 141.6

(51) Int. Cl. B01J 20/12; B01J 20/22

(52) U.S. Cl. 502/401; 502/407

(57) ABSTRACT

A superabsorbent formulation is described for absorbing liquids (for example in an ostomy, incontinence or woundcare application), the formulation comprising superabsorbent (100 pbw), silica (3-20 pbw), water (0.5-8 pbw) and glycerol (5-40 pbw). The superabsorbent and silica are mixed together in a first production stage (10), to coat the superabsorbent particles with silica. The glycerol and water are added during a second production stage (12). The effect of the silica is to increase the amount of glycerol and water which can be taken up in the formulation, thereby producing a product with greater structural stability when consolidated (compressed).

### FIELD OF THE INVENTION

This invention relates to an absorbent material, and to a method of producing the material. The invention is especially suitable for absorbing liquid matter excreted by the body (e.g. for use in ostomy, incontinence or woundcare), and/or for absorbing aqueous matter, but it is not limited exclusively to these fields.

### BACKGROUND TO THE INVENTION

GB-A-2301350 and EP-A-0891758 describe superabsorbent formulations and methods of producing articles containing superabsorbent material. A significant aspect of the superabsorbent formulation is the inclusion of glycerol and water, which binds the superabsorbent powder granules together when compressed, to form a consolidated mass. The superabsorbent material can be formed into tablets, or compressed between upper and lower layers to form a sheet-like product.

However, there are practical limits on the amount of glycerol and water which the superabsorbent is able to take up as a consolidatable mass. This limits the structural stability of the consolidated mass, and makes it vulnerable to at least some degree of shedding (particularly at the edges). Also, articles made of the material tend not to be flexible, and may shed material if bent or flexed.

It would be desirable to provide a way of increasing the amount of glycerol and water which can be incorporated in the formulation without detracting significantly from other advantageous characteristics of the superabsorbent formulation.

### SUMMARY OF THE INVENTION

The present invention has been devised bearing the above in mind.

Broadly speaking, one aspect of the invention is to include silica in a formulation including superabsorbent material (e.g. powder or granules). This has been found to provide the following advantages:

(a) the silica acts as a lubricant, enabling the superabsorbent particles to flow more easily, thus making handling of the superabsorbent particles easier, and leading to easier mixing and compressing processes; and

(b) the silica also enables more glycerol/water to be taken up by the superabsorbent material. It is believed that the silica enables the glycerol/water to penetrate between the particles of superabsorbent material more completely, thereby increasing the quantity of glycerol/water which can be taken up.

Preferably, the amount of silica present (per 100 parts wt of superabsorbent material) is at least 3 parts, more preferably at least 4 parts, more preferably at least 5 parts, more preferably at least 6 parts, more preferably at least 7 parts, and in one form at least 8 parts.

Preferably, the amount of silica present (per 100 parts wt of superabsorbent material) is not greater than 20 parts, more preferably not greater than 15 parts, more preferably not greater than 10 parts and, in one form, not greater than 8 parts.

The optimum amount of silica depends to some extent on the size of the particles of superabsorbent. Generally, it is preferred that the silica be present in such a quantity to provide a surface coating on substantially all of the superabsorbent particles. Preferably, each particle, is substantially entirely coated. It will be appreciated that a smaller particle size results in a larger surface area to be coated per unit volume, thus requiring a greater quantity of silica for optimum effect.

The superabsorbent particles may comprise an alkali metal polyacrylate (e.g. sodium polyacrylate), or some other polyacrylate, or other material which provides superabsorbent properties (defined generally as the ability to absorb many times their own weight of liquid matter). Suitable materials include for example, water-swellable polymers.

Preferably, the formulation includes glycerol. Alternatively, another non-volatile lubricious polyhydroxy compound may be used which is water-soluble or water-dispersible at or below 40° C. and is liquid at room temperature (15 to 20° C.). Suitable other compounds include, for example: propane 1-2 diol; polyethylene glycol 200 (or 300); or sorbitol.

Preferably, the amount of glycerol (or other material) is 5-40 parts per 100 parts of the superabsorbent material, more preferably 5-30 parts, more preferably 10-25 parts. In one embodiment, the amount of glycerol (or other material) is between 12 and 18 parts per 100 parts of superabsorbent.

Preferably, the formulation also includes water. Preferably, the water is present in an amount of 0.5 to 10 parts by weight per 100 parts of superabsorbent, more preferably 0.5 to 6 parts. In one example, the amount of water is between 3 and 5 parts.

The formulation may also include additives, for example, a malodour counteractant.

In another aspect, the invention provides a method of producing an absorbent material, the method comprising:

(a) mixing together superabsorbent particles and silica; and

(b) adding to the mixture from step (a) a cohesive formulation to make the mixture consolidatable.

Preferably, the silica and superabsorbent particles are mixed to provide a mixture in which substantially all of the superabsorbent particles are coated with silica. Preferably, the particles are substantially entirely coated with silica.

Preferably, the cohesive formulation is added after the mixing in step (a) is carried out.

Preferably, the cohesive formulation includes glycerol and water. Instead of glycerol may be used another non-volatile lubricious polyhydroxy compound which is water-soluble or water-dispersible at or below 40° C. and is liquid at room temperature (15 to 20° C.).

### BRIEF DESCRIPTION OF THE DRAWINGS

An embodiment of the invention is now described by way of example only, with reference to the accompanying drawings, in which:

FIG. 1 is a schematic flow diagram showing a production process for producing an absorbent material;

FIGS. 2a and 2b are schematic drawings showing the superabsorbent granules before (a) and after (b) mixing with silica; and

FIG. 3 is a schematic drawing of apparatus for consolidating the material to form shaped articles.

### DESCRIPTION OF PREFERRED EMBODIMENT

An example superabsorbent formulation comprises, in parts by weight (pbw):

| | | |
|---|---|---|
| Superabsorbent | 100 | pbw |
| Silica | 6-10 | pbw |
| Glycerol | 14 | pbw |
| Water | 4 | pbw. |

A suitable superabsorbent material is, for example, sodium polyacrylate available under trade name FemDry 33C from Chemdal. Sodium polyacrylate superabsorbent materials are also available from Dow Chemicals and from Hoescht.

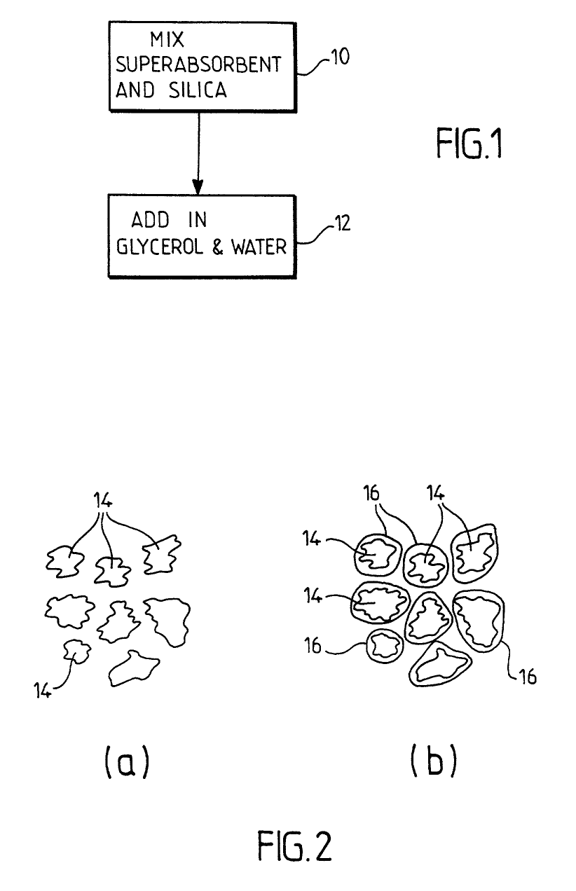

Referring to FIGS. 1 and 2, the formulation is prepared in first and second stages 10 and 12. The first stage is to mix together the superabsorbent granules and the silica. FIG. 2a shows the superabsorbent granules 14 prior to mixing, and FIG. 2b shows the granules 14 after mixing. As can be seen from FIG. 2b, the effect of mixing is to coat the granules 14 with a thin coating of silica 16. The silica 16 acts as a lubricant making the granules easier to flow, and therefore easier to mix.

The second stage 12 is to add a premix of glycerol and water to the silica coated superabsorbent formulation. The effect of the silica is generally to enable the superabsorbent formulation to take up a greater quantity of glycerol/water than if the silica were absent. It is believed that this is as a result of the silica (again acting as a form of lubricant) permitting the glycerol/water to penetrate more completely between the superabsorbent granules 14. The optimum quantity of silica depends at least to some extent on the size of the superabsorbent granules 14. It is preferred that the quantity of silica be sufficient to coat substantially the entire surface of the superabsorbent particles 14. During the second stage 12, the formulation is mixed to a powder consistency.

The superabsorbent formulation can be formed into a desired shaped article by compression, which consolidates the powder structurally, in the same manner as that described in GB-A-2301350 and EP-A-0891758 referred to hereinbefore. The presence of the glycerol/water (particularly in the higher quantity than that attainable hitherto) enables the mixture to be compressed at room temperature with only relatively mild pressure being required. In most cases no other heat is required. Moreover, the increased quantity of glycerol/water provides greater structural stability than that achievable hitherto, so that the formed article is less prone to shedding, and can be at least partly flexible if desired.

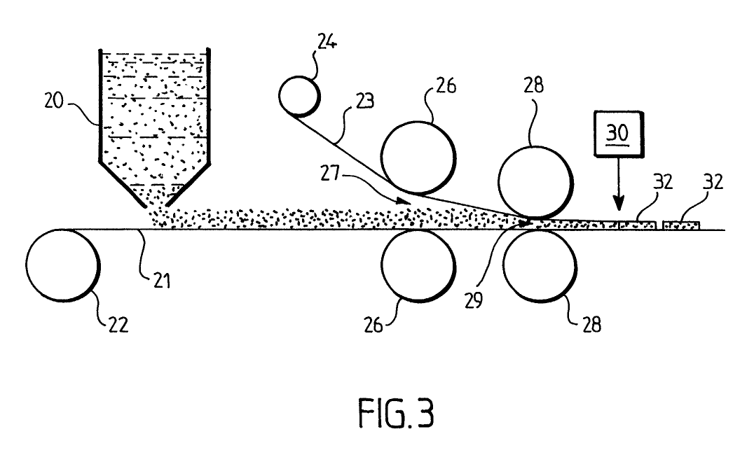

FIG. 3 illustrates, by way of example, apparatus 18 for forming a sheet of superabsorbent, suitable for use in ostomy, incontinence or woundcare applications. The powder formulation is fed from a supply 20 onto a travelling sheet 21 of tissue paper which is pulled off a supply roll 22. A second (overhead) sheet 23 of tissue paper is fed from a second supply roll 24 and these two sheets sandwich the powder between them. The product passes between a first pair of rolls 26 which form a first nip 27 and to a second pair of rolls 28 forming a second nip 29. The inter-roll spacing at the second nip 29 may be for example 0.1 to 2.0 mm. That at the first nip 27 may be 0.75 to 4 mm. No external heat is applied. The resulting product is a flat sheet which can then be cut into suitable shapes, e.g. rectangles 32, and can be directly placed in an ostomy pouch or incontinence pouch. It has been found to rapidly absorb a liquid such as urine. In tests, over 60 ml of synthetic urine were absorbed in under 60 seconds, usually under 40 seconds, by a product of one square centimeter area and 2 mm thickness made by the method described above.

If desired, the sheet may be processed during production to form packet-like articles, as described in EP-A-0891758.

Reference has been made in the above specification to malodour counteractants. One example of a malodour counteractant is a bactericide, e.g. benzyl alkonium chloride. Another example is a fragrance. Other examples are included in a range of bactericides manufactured by ConvaTec™ (Calgon-Vestal Div.). Yet other malodour counteractants which may be used are methylchlorosiothiazolinone, methylisothiazolinone, or denatonium benzoate.

It will be appreciated that the foregoing description is merely illustrative of preferred forms of the invention, and that many modifications may be made within the scope of the invention. Aspects believed to be of particular importance are identified in the claims. However, the applicant claims protection for any novel feature or idea described and/or illustrated herein whether or not emphasis has been placed thereon.

1. A formulation for utilisation to absorb liquid, comprising:
superabsorbent;
silica;
water; and
a non-volatile lubricious polyhydroxy compound which is water-soluble or water-dispersible at or below 40° C. and is liquid at room temperature.

2. A formulation according to claim 1, wherein relative quantities in the formulation are, in parts by weight (pbw):

| | | |
|---|---|---|
| superabsorbent | 100 | pbw |
| silica | 3-20 | pbw |
| water | 0.5-8 | pbw |
| said lubricious polyhydroxy compound | 5-40 | pbw. |

3. A formulation according to claim 2, wherein the silica is present in a quantity to provide a surface coating on at least the majority of the surface area of the superabsorbent.

4. A formulation according to claim 3, wherein the silica is present in a quantity to provide a surface coating on substantially the entire surface area of the superabsorbent.

5. A formulation according to 2 wherein the silica is present in a quantity of at least 4 pbw .

6. A formulation according to claim 5, wherein the silica is present in a quantity of at least 5 pbw.

7. A formulation according to claim 6, wherein the silica is present in a quantity of at least 6 pbw.

8. A formulation according to claim 7, wherein the silica is present in a quantity of at least 7 pbw.

9. A formulation according to claim 8, wherein the silica is present in a quantity of at least 8 pbw.

10. A formulation according to claim 2, wherein the silica is present in a quantity of not greater than 20 pbw.

11. A formulation according to claim 1 wherein the polyhydroxy compound is glycerol.

12. A formulation according to claim 2, wherein the polyhydroxy compound is present in an amount of 5-30 pbw.

13. A formulation according to claim 2, wherein the polyhydroxy compound is present in an amount of at least 12 pbw.

14. A formulation according to claim 13, wherein the polyhydroxy compound is present in an amount of at least 13 pbw.

15. A formulation according to claim 14, wherein the polyhydroxy compound is present in an amount of at least 14 pbw.

16. A formulation according to claim 2, wherein the water is present in an amount of 0.5-6 pbw.

17. A formulation according to claim 2, wherein the water is present in an amount of at least 3 pbw.

18. A formulation according to claim 17, wherein the water is present in an amount of at least 4 pbw.

19. A formulation according to claim 1, wherein the superabsorbent comprises a water swellable polymer.

20. A formulation according to claim 19, wherein the superabsorbent comprises a polyacrylate.

21. A formulation according to claim 20, wherein the polyacrylate is an alkali metal polyacrylate.

22. A formulation according to claim 21, wherein the superabsorbent comprises sodium polyacrylate.

23. A method of producing a superabsorbent formulation, the method comprising:
(a) mixing together superabsorbent and silica to at least partly coat the superabsorbent with silica; and
(b) mixing with the silica coated superabsorbent, water and a non-volatile lubricious polyhydroxy compound which is water-soluble or water-dispersible at or below 40° C. and is liquid at room temperature.

24. A method according to claim 23, wherein the lubricious polyhydroxy compound is glycerol.

25. A method according to claim 23, wherein the relative quantities in the formulation are, in parts by weight (pbw):

| | | |
|---|---|---|
| superabsorbent | 100 | pbw |
| silica | 3-20 | pbw |
| water | 0.5-8 | pbw |
| said lubricious polyhydroxy compound | 5-40 | pbw. |

26. A method according to claim 23, wherein the silica is present in a quantity to provide a surface coating over substantially the majority of the surface area of the superabsorbent.

27. A method according to claim 26, wherein the silica is present in a quantity to provide a surface coating on substantially the entire surface area of the superabsorbent.

28. A method of producing a superabsorbent formulation, the method comprising:
(a) providing superabsorbent particles which are substantially entirely coated with silica; and
(b) mixing with the silica coated superabsorbent, water and a non-volatile lubricious polyhydroxy compound which is water-soluble or water-dispersible at or below 40° C. and is liquid at room temperature.

29. An ostomy, incontinence or woundcare product comprising or containing a superabsorbent formulation, the formulation comprising:
superabsorbent;
silica;
water; and
a non-volatile lubricious polyhydroxy compound which is water-soluble or water-dispersible at or below 40° C. and is liquid at room temperature.

30. An ostomy product according to claim 29, wherein the product is an ostomy pouch.

31. Use of a superabsorbent formulation in an ostomy, incontinence or woundcare product, the formulation comprising:
superabsorbent;
silica;
water; and
a non-volatile lubricious polyhydroxy compound which is water-soluble or water-dispersible at or below 40° C. and is liquid at room temperature.
